(19) United States
(12) Patent Application Publication
(10) Pub. No.: US 2007/0116932 A1
(43) Pub. Date: May 24, 2007

(54) Device and method of making a device having a flexible layer structure

(75) Inventor: Leendert Van Der Tempel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/574,145

(22) PCT Filed: Sep. 30, 2004
(86) PCT No.: PCT/IB04/51931

§ 371 Date: Mar. 29, 2006

(30) Foreign Application Priority Data
Oct. 4, 2003 (GB) 0323286.5

(51) Int. Cl. B31F 1/20; B32B 3/00

(52) U.S. Cl. 428/172; 156/205; 156/210; 156/64; 428/167

(57) ABSTRACT

A device such as a flexible AMLCD is described comprising first (10) and second layers (11), wherein the first layer is a flexible substrate and the second layer is a brittle ITO conduction line applied to the substrate. The ITO layer has a corrugated structure and is in contact with the substrate along a substantial portion of the length of the ITO layer so as to prevent fracture of the ITO layer when the flexible substrate is deformed. The ITO layer may be divided into portions (16, 17), the length of the portions being selected to prevent fracture when the flexible substrate is deformed to a predetermined radius of curvature.

This application relates to the field of flexible devices, particularly but not exclusively to flexible electronic devices including flexible electronic displays. More particularly, this application relates to the structure of a layer on a flexible substrate, wherein the structure of the layer enables it to withstand higher levels of strain before fracture than conventional layers.

Flexible substrates are substrates that may be deformed whilst maintaining their functional integrity. They can, for example, be made of plastic, metal foil or very thin glass; in general they will have a low elastic modulus or be relatively thin. The development of flexible substrates allows greater freedom in the design of electronic devices, and thus enables the development of previously impracticable electronic appliances in numerous areas of technology. One example is the development of flexible electronic displays. These have numerous benefits over the rigid devices that are currently available. Curved or roll-up displays could be developed which are cheap enough to manufacture and have sufficient flexibility and durability such that they could, one day, rival paper.

A limitation to the production of flexible displays is that the flexible substrates often require coatings of more brittle materials. An example of one of these materials is the Indium Tin Oxide (ITO) electrode used in active matrix liquid crystal displays (AMLCDs). An example of the use of ITO in AMLCDs is provided in U.S. Pat. No. 5,130,829. Brittle materials, such as ITO, fracture when exposed to strains above a certain limit and thus lose functionality. Due to its brittleness, when strained, ITO is likely to crack or delaminate, having the effect of reducing its conductivity. This greatly inhibits the performance of the display.

WO-A-96/39707 describes an electrode for use on flexible substrates, which is designed to retain more of its conductivity for greater amounts of strain. To achieve this, a coating of a second more flexible conductive material is applied such that it is in contact with the relatively brittle electrode material. Accordingly, when the brittle electrode is put under strain and therefore starts to crack, electrical continuity is maintained via the second, more flexible material.

The drawback of this approach is that the second material has a much greater resistivity than the brittle electrode material. The price for increased flexibility is an increase in resistance of the electrode, and accordingly this approach is not applicable where good electrode conductivity is required, such as in electronic displays.

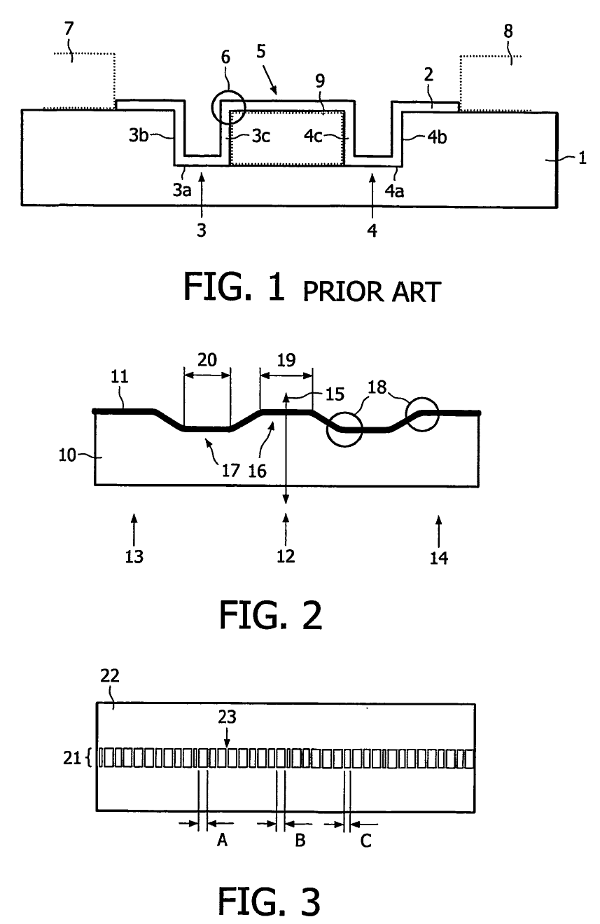

WO-A-02/45160 describes a flexible metal connector for providing a link between rigid substrate portions. A cross-sectional view of a flexible substrate 1 having a connector 2 with a similar structure to that described in WO-A-02/45160 is shown in FIG. 1. The connector 2 is formed by first and second troughs 3, 4 connected by a ridge 5. The base 3a, 4a and one side 3b, 4b of each of the first and second troughs are in contact with the substrate 1. However, the other side 3c, 4c of each of the first and second troughs and the ridge 5 connecting the troughs 3, 4 are not in contact with the substrate 1.

The structure of the connector 2 is such that it is able to flex in a concertina-like manner when strained and may thus withstand larger amounts of strain before fracture than conventional connectors. However, using this particular structure for brittle materials may be inappropriate because, as longitudinal strain is applied to the brittle conductor material, there would be a concentration of stress in the corners of the connector 2, for example the left-hand corner 6 of the ridge 5, causing the material to fracture.

Furthermore, a connector such as that of WO-A-02/45160, having raised bridging portions, would require several photolithographic steps for its manufacture, as are described in WO-A-02/45160. For example, in one process, the first step would be the deposition of a layer of photoresist onto the surface of the substrate 1. This would then be patterned to leave three blocks, one 7 marking the left-hand boundary of the connector 2, one 8 marking the right-hand boundary, and the last 9 formed to shape the ridge 5 of the connector 2. The next step would be that of depositing a thin electroplating seed layer, for instance copper over chromium, to the substrate, covering the blocks of photoresist 7, 8, 9 and the exposed substrate. The connector 2 would then be electroplated over the seed layer. In a final stage, the photoresist blocks 7, 8, 9 are removed.

These steps required for the fabrication of the connector 2 of FIG. 1 add time and expense to the production process of flexible devices.

The present invention aims to address the above problems.

According to a first aspect of the invention there is provided a device comprising first and second layers wherein the first layer is flexible and the second layer has a corrugated structure and is in contact with the first layer along a substantial portion of the length of the second layer so as to prevent fracture of the second layer when the first layer is deformed.

The second layer being in contact with the first layer along a substantial portion of the length of the second layer ensures that the second layer is both robust and able to withstand greater strains than would be possible with conventional flat layers of functional materials.

The device may comprise a third layer in contact with the first layer, wherein the third layer comprises a substrate and the first layer is a coating on the substrate.

Applying an intermediate layer between the substrate and the second layer may facilitate the vertical movement of portions of the second layer and thus aid the absorption by the second layer of longitudinal strains applied to the substrate. Also, the steps required for patterning a coating on a substrate to accommodate the corrugated top layer may be simpler than those required for patterning a substrate directly.

The second layer may comprise a series of adjoining troughs and ridges, each trough and each ridge including substantially flat portions. The widths of the substantially flat portions may be selected to prevent fracture when the first layer is deformed to a predetermined radius of curvature.

The widths may be selected to be less than a predetermined length, the predetermined length being dependent on the average length between fractures for a continuous layer deformed to the predetermined radius of curvature.

According to a second aspect of the invention there is provided a method of making a device comprising first and second layers wherein the first layer is flexible and the second layer has a corrugated structure and is in contact with the first layer along a substantial portion of the length of the second layer so as to prevent fracture of the second layer when the first layer is deformed, the second layer comprising a plurality of interconnected portions each having a portion length, the method including selecting the portion length to prevent fracture when the first layer is deformed to a predetermined radius of curvature.

The method may further comprise determining a spacing between fractures for a continuous layer of material which forms the first layer, when deformed to a predetermined radius of curvature, and selecting the portion length to be a value that is dependent on the determined spacing.

The method may comprise determining an average spacing between the fractures.

For a better understanding of the invention, embodiments thereof will now be described, purely by way of example, with reference to the accompanying drawings, in which:

FIG. 1 is a cross-sectional view of a prior art connector on a flexible substrate;

FIG. 2 is a cross-sectional view of a corrugated layer on a flexible substrate according to the invention;

FIG. 3 is a plan view of a conventional ITO layer on a flexible substrate that has undergone bending;

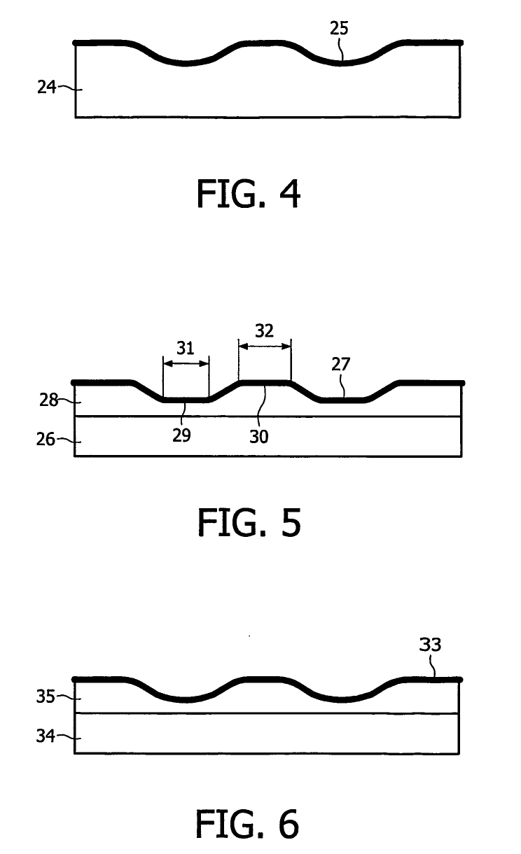

FIG. 4 is a cross-sectional view of a curved corrugated layer on a flexible substrate according to the invention;

FIG. 5 is a cross-sectional view of a corrugated layer on a coated flexible substrate according to the invention; and

FIG. 6 is a cross-sectional view of a curved corrugated layer on a coated flexible substrate according to the invention.

Referring to FIG. 2, a portion of the structure of a flexible active matrix liquid crystal display (AMLCD) is illustrated in cross-sectional view. This comprises a first layer 10 and a second layer 11. In this example, the second layer 11 is a layer of Indium Tin Oxide (ITO), which is a brittle material used for conductor lines in AMLCDs. Other brittle layers having other functions could form the second layer. The ITO layer 11 is supported along its length by the first layer 10, which, in this example, is a polyvinyl chloride substrate. The substrate 10 is flexible and, in particular, the centre portion 12 can move up and down vertically in relation to the end portions 13, 14, as depicted by the double-ended arrow 15 illustrated in FIG. 2. When this happens, stress is exerted on the substrate 10, the stress being at its greatest at the upper and lower extremities of the substrate 10. Depending on the direction of movement of the centre portion 12 in relation to the ends 13, 14, either a compressive or tensile stress will be exerted on the upper surface of the substrate 10. This will cause a strain in the brittle ITO layer 11.

To enable the ITO layer 11 to withstand higher strains before fracture, it is provided with a corrugated structure shown in FIG. 2, comprising a series of connected upper and lower flat portions 16, 17, with curved intersections 18 between adjoining upper and lower portions 16, 17. This gives the layer 11 “concertina-like” properties, such that the upper and lower portions 16, 17 can move vertically apart or together in relation to each other to reduce or increase the longitudinal length of the ITO layer 11, and thus enable it to absorb larger longitudinal strains. The terms “longitudinal strain” and “longitudinal length” used throughout this specification refer to strains and lengths across the substrates as shown in the Figures, for instance from the left-hand end 13 to the right-hand end 14 of FIG. 2.

As is shown in the example of FIG. 2, the structure of the functional layer 11 is in contact with the substrate 10 along the whole of its length. This ensures that the functional layer 11 is both robust and able to withstand greater strains than would be possible with conventional flat layers of functional materials.

The functional layer 11 may be any of numerous brittle functional coatings, such as a scratch-resistant coating, a solvent or gas resistant coating, or a conductive coating such as Transparent Conductive Oxide (TCO), an example being Indium Tin Oxide (ITO). These coatings generally have higher values of Young's Modulus to those of the materials used for the substrate 10. Accordingly, they are more likely to fracture when strains, at which the substrate 10 may be stable, are exerted on them.

The thickness of the layer 11 and of the flexible substrate 10 are dependent on the particular application and the materials used. In the case of an AMLCD having a flexible polyvinyl chloride substrate with an ITO electrode layer, the thickness of the substrate is likely to be to the order of 0.1 mm to 1 mm with an ITO layer thickness of 50 to 200 nm.

To produce the corrugated structure of the substrate 10 of FIG. 2, various techniques would be apparent to the skilled person. For instance, any of a number of replication techniques could be used. One example is the technique of hot embossing or micro-embossing. In this process a thermoplastic such as acrylic, polyvinyl chloride, polycarbonate, polystyrene or polysulfone is heated and pressurised into a molten form, and patterned using a microstructure tooling to produce the require surface topography. Examples of this process are described in more detail in U.S. Pat. No. 4,601,861 and U.S. Pat. No. 4,486,363.

The replication technique described above may well be required for patterning the substrate for reasons other than for introducing the corrugated topography. In this case, the patterning process for the corrugated topography and that for the other required patterning can be combined, with the advantage that no additional manufacturing processes are required to form the corrugated layer, and thus manufacturing time is minimised.

Following the patterning of the upper surface of the substrate 10 with the corrugated topography, the functional layer 11 may be applied. The functional layer 11 may, for example, be formed by vacuum deposition, for example spluttering or vapour deposition, followed by photolithographic patterning. Alternatively, a printing technique such as ink-jet printing, soft lithographic techniques such as microcontact printing, flexographic printing or screen printing may be used. The specific processes involved in these methods and other methods for applying the functional layer 11 would be apparent to the skilled person. The choice of method and processes involved in the chosen method will depend on the exact material required for the functional layer 11.

The lengths 19, 20 of the flat portions 16, 17 of the functional layer 11 will influence the properties of the functional layer 11 when under strain. When crack formation in an ITO line on a flexible substrate undergoing tensile or bending tests is analysed, a statistical pattern emerges. For a certain radius of curvature of the flexible substrate, the ITO line may, for example, crack perpendicularly at roughly 300 micron intervals. However, each of the 300 micron sections thus formed will then be stable and will not exhibit further cracking until the substrate undergoes a further change to a smaller radius of curvature. Hence, for each radius of curvature to which the flexible substrate is bent, there is a length of ITO line that will be stable and therefore less likely to crack. This property is also true of layers of other materials on flexible substrates. The length of portions of the layer on the substrate that will be stable will be dependent on the radius of curvature of the substrate, the thickness of the substrate and the brittleness of the material forming the layer, which will depend on the specific application for which the invention is being used.

FIG. 3 is a plan view of a conventional ITO layer 21 on a flexible substrate 22 following deformation to a specific radius of curvature. As can be seen, cracks 23 have formed at intervals along the length of the ITO layer 21. The average distance between these cracks is dependent on the radius of curvature of the substrate 22. At a certain radius of curvature, ‘r’, of the substrate 22, the distance between the cracks (such as the distances A, B and C) may be measured. An average may then be taken of these values. A critical length, above which continuous portions of brittle layers on the flexible substrate when bent to radius r are likely to fracture, will be dependent on this average length. In practice, it has been found that the critical length for continuous portions may be up to three times the average length. Accordingly, the lengths 19, 20 of the continuous portions 16, 17 of the ITO layer 11 are set to be no greater than the critical length, making the layer less likely to fracture when the substrate 10 is bent up to the radius of curvature r. FIG. 4 is a cross-sectional view of a flexible substrate 24 with a functional layer 25 similar to those shown in FIG. 2. In this case, the corrugated layer 25 is undulated, rather than comprising the substantially flat portions 16, 17 of FIG. 2. This addresses the problems associated with the functional layer 11 having larger stresses at the intersections 18 of adjoining flat portions. Stresses in the functional layer 25 of FIG. 4 will be more evenly distributed throughout the functional layer 25, due to its curved shape. This structure is therefore less likely to fracture.

The methods of fabricating the substrate 24 and functional layer 25 having undulating topographies are similar to those for fabricating the substrate 10 and functional layer 11 of FIG. 2.

FIG. 5 is a cross-sectional view of a flexible substrate 26 with a corrugated functional layer 27. However, in this case, a layer 28 of a further material such as a UV-curable acrylate lacquer is interposed between the functional layer 27 and the flexible substrate 26. One advantage of this interposed layer 28 is that it facilitates the vertical movement of the flat portions 29, 30 in relation to each other and facilitates vertical movement of the flat lower and upper portions 29, 30 in relation to the substrate 26. This aids the absorption of longitudinal strains applied to the functional layer 27. Also, the steps required for patterning the interposed layer 28 are simpler than those required for patterning the substrate 26 directly.

A well-known process to produce the substrate 26 with the UV-curable acrylate lacquer coating 28 involves placing free-flowing lacquer between a microstructure tooling having a reverse pattern of the desired topographical structure and a film. The lacquer is then exposed to UV light, which makes it solidify and bond permanently to the film. The functional layer 27 may then be added using a conventional technique, such as those described above for applying the functional layer 11 of FIG. 2.

The lengths 31, 32 of the flat portions 29, 30 of the corrugated functional layer 27 will influence the properties of the functional layer 27 when under strain, in a similar manner to the lengths of the flat portions 16, 17 of FIG. 2. Accordingly, these lengths are set to be no greater than the critical length described above in relation to FIG. 3.

In a similar manner to the functional layer 25 of FIG. 4, FIG. 6 depicts an example of an undulating functional layer 33 on a flexible substrate 34. A further layer 35 of a further material such as UV-curable acrylate lacquer is interposed between the functional layer 33 and the substrate 34.

From reading the present disclosure, other variations and modifications will be apparent to persons skilled in the art. Such variations and modifications may involve equivalent and other features which are already known in the design, manufacture and use of flexible electronic devices and which may be used instead of or in addition to features already described herein.

In particular, the invention is not limited to use in an AMLCD display, nor to a polycarbonate substrate. It is also applicable to any flexible substrate having a functional coating. It is also applicable to other types of display, such as foil displays, e-ink displays, poly-LED displays, O-LED displays and other electroluminescent displays.

Also, the illustrations of FIGS. 2 and 4 to 6 depict the corrugated surface topographies as being regular. However, they may be made irregular, for instance the ridges and troughs having irregular heights, whilst still having the benefits of the invention. Also, the shape of the ridges and troughs need not be limited to a shape formed by three substantially flat portions as illustrated in FIGS. 2 and 5 or an undulated shape as illustrated in FIGS. 4 and 6.

Further embodiments may comprise more than one interposed layer 28, 35, for instance several layers forming a stack of interposed layers. The interposed layer 28, 35 on which the functional layer is coated need not be patterned to have the corrugated topography. In alternative embodiments, other interposed layers in a stack of interposed layers, or the substrate 26, 34, are patterned with a corrugated topography. In this case, the interposed layer 28, 35 on which the functional layer is coated is of uniform thickness and has a corrugated structure by virtue of the corrugated topography of the layers or substrate upon which it is applied.

Although claims have been formulated in this application to particular combinations of features, it should be understood that the scope of the disclosure of the present invention also includes any novel features or any novel combination of features disclosed herein either explicitly or implicitly or any generalisation thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A device comprising first (10, 24, 28, 35) and second (11, 25, 27, 33) layers wherein:
the first layer is flexible; and
the second layer has a corrugated structure and is in contact with the first layer along a substantial portion of the length of the second layer so as to prevent fracture of the second layer when the first layer is deformed.

2. A device according to claim 1, wherein the first layer (10, 24) is a substrate.

3. A device according to claim 1, further comprising a third layer (26, 34) in contact with the first layer (28, 35), wherein the third layer (26, 34) comprises a substrate and the first layer (28, 35) comprises one or more coatings on the substrate.

4. A device according to claim 3, wherein the third layer (26, 34) comprises a corrugated topography.

5. A device according to claim 3, wherein the first layer (28, 35) comprises an acrylate lacquer.

6. A device according to claim 1, wherein the second layer (11, 25, 27, 33) is a coating on the first layer (10, 24, 28, 35).

7. A device according to claim 1, wherein the first layer (10, 24, 28, 35) comprises a corrugated topography.

8. A device according to claim 1, wherein the second layer (11, 25, 27, 33) comprises a series of adjoining troughs and ridges, each trough and each ridge including substantially flat portions (16, 17, 29, 30)

9. A device according to claim 8, wherein the widths (19, 20, 31, 32) of the substantially flat portions (16, 17, 29, 30) are selected to prevent fracture when the first layer (10, 24, 28, 35) is deformed to a predetermined radius of curvature.

10. A device according to claim 9, wherein the widths (19, 20, 31, 32) are selected to be less than a predetermined length, the predetermined length being dependent on the average length between cracks (23) for a continuous layer deformed to the predetermined radius of curvature.

11. A device according to claim 8, wherein the transitions (18) between the troughs and ridges are curved.

12. A device according to claim 8, wherein the substantially flat portions (16, 17, 29, 30) are interconnected to provide a continuous path for an electric current.

13. A device according to claim 1, wherein the corrugated structure comprises an undulating topography.

14. A device according to claim 2, wherein the substrate comprises polyvinyl chloride.

15. A device according to claim 1, wherein the second layer (11, 25, 27, 33) comprises a transparent conductor.

16. A device according to claim 15, wherein the second layer (11, 25, 27, 33) comprises a conductive oxide.

17. A device according to claim 1, comprising a display.

18. A method of fabricating a device comprising first (10, 24, 28, 35) and second (11, 25, 27, 33) layers wherein the first layer is flexible and the second layer has a corrugated structure and is in contact with the first layer along a substantial portion of the length of the second layer so as to prevent fracture of the second layer when the first layer is deformed, the second layer comprising a plurality of interconnected portions (16, 17, 29, 30) each having a portion length (19, 20, 31, 32), the method including selecting the portion length to prevent fracture when the first layer is deformed to a predetermined radius of curvature.

19. A method according to claim 18, further comprising determining a spacing between cracks (23) for a continuous layer of material when deformed to a predetermined radius of curvature, and selecting the portion length to be a value that is dependent on the determined spacing.

20. A method according to claim 19, comprising determining an average spacing between the cracks (23).
